(19) United States
(12) Patent Application Publication
(10) Pub. No.: US 2026/0094994 A1
(43) Pub. Date: Apr. 2, 2026

(54) LEVER-TYPE CONNECTOR AND CONNECTOR ASSEMBLY

(71) Applicant: SUMITOMO WIRING SYSTEMS, LTD., Mie (JP)

(72) Inventors: Stefan LEWOSKI, Mie (JP); Ryousuke GIGA, Mie (JP); Philipp BÖHM, Wolfsburg (DE); Victor STOIANOVICI, Wolfsburg (DE)

(21) Appl. No.: 19/336,087

(22) Filed: Sep. 22, 2025

(30) Foreign Application Priority Data
Sep. 30, 2024 (JP) 2024-170005

(51) Int. Cl. H01R 13/629

(52) U.S. Cl. CPC H01R 13/62933

(57) ABSTRACT

A lever-type connector includes a rotation mechanism that enables a lever to rotate with respect to a connector housing, and a position holding mechanism that holds the lever at an initial position. The position holding mechanism holds the lever at the initial position by having a protrusion part formed on one of a shaft part and a shaft hole of the rotation mechanism engage with a regulating groove formed on another one of the shaft part and the shaft hole in a case where the lever is positioned at the initial position. The position holding mechanism causes the lever to deform by interference with a mating connector in a process of fitting the connector housing with the mating connector, thereby releasing an engagement of the protrusion part and the regulating groove to allow a rotation operation of the lever.

### CROSS-REFERENCE TO RELATED APPLICATIONS

This application is based on and claims priority from Japanese Patent Application No. 2024-170005, filed on Sep. 30, 2024, with the Japan Patent Office, the disclosure of which is incorporated herein in its entirety by reference.

### TECHNICAL FIELD

The present disclosure relates to a lever-type connector and a respective connector assembly.

### BACKGROUND

Conventionally, a rotating lever-type connector in which, in a case where a female connector housing is to be fitted with a male connector housing, the female connector housing is completely fitted with the male connector housing, by operating a rotating lever provided on the female connector housing, is well-known such as disclosed in Japanese Patent Laid-open Publication No. 2007-035592. In this rotational lever-type connector, a protrusion on the male connector housing engages with a cam groove formed on the rotating lever. When the rotating lever is operated, the female connector housing is guided so as to enter the male connector housing, by a cam structure of a cam groove formed in a curved shape and a protrusion that engages with the cam groove, thereby causing the connector housings to be completely fitted.

Incidentally, this type of rotating lever-type connector includes a position holding structure for holding the rotating lever at an initial position prior to a rotation operation. This position holding structure holds the rotating lever at the initial position, for example, by engaging a protrusion piece formed on the rotating lever with a groove on the male connector housing. The engagement of the protrusion piece and the groove is released, for example, by pressing with a rib formed on the male connector housing to separate the protrusion piece from the groove, in a process of fitting the female connector housing with the male connector housing.

Here, it is necessary for the protrusion piece to be a moving part that can be engaged with and disengaged from the groove, specifically, an elastically deformable moving piece. In this way, since it is necessary for the protrusion piece to have a movable shape with respect to a lever main body, there is a concern that the shape will deform at the time of an operation of the rotating lever. Moreover, according to the circumstances, there is also a concern that cracks or splinters will occur in the protrusion piece. As stated above, there is a problem in that the relatability of the rotating lever-type connector is low with respect to the durability of an article.

### SUMMARY

An objective of the present disclosure is to provide a lever-type connector and to a respective connector assembly having an improved overall operability.

This object is solved according to the invention by the features of the independent claims. Particular embodiments of the invention are subject of the dependent claims.

According to one aspect, there is provided a lever-type connector to be connected to a mating connector by having a connector housing to be fitted with the mating connector drawn into the mating connector in a process of operating a lever from an initial position to a fitted position, the lever being rotatably or pivotably provided on the connector housing, the lever-type connector including a operation mechanism that enables the lever to rotate or pivot with respect to the connector housing by at least partly inserting a shaft part formed on one of the connector housing and the lever into a shaft hole formed on another one of the connector housing and the lever, and at least one position holding mechanism that holds the lever at the initial position by having at least one protrusion part formed on one of the shaft part and the shaft hole engage with at least one regulating groove formed on another one of the shaft part and the shaft hole in a case where the lever is positioned at the initial position, in which the position holding mechanism causes the lever to deform by interference with the mating connector in a process of at least partly fitting the connector housing with the mating connector, thereby releasing an engagement of the protrusion part and the regulating groove to allow a rotation or pivotal operation of the lever.

Accordingly, an improved overall operability is achieved particularly by improving the reliability of a position holding mechanism that holds a lever at an initial position.
[1] According to a particular embodiment, there is provided a lever-type connector to be connected to a mating connector by having a connector housing to be fitted with the mating connector drawn into the mating connector in a process of operating a lever from an initial position to a fitted position, the lever being rotatably provided on the connector housing, the lever-type connector including a rotation mechanism that enables the lever to rotate with respect to the connector housing by inserting a shaft part formed on one of the connector housing and the lever into a shaft hole formed on another one of the connector housing and the lever, and a position holding mechanism that holds the lever at the initial position by having a protrusion part formed on one of the shaft part and the shaft hole engage with a regulating groove formed on another one of the shaft part and the shaft hole in a case where the lever is positioned at the initial position, in which the position holding mechanism causes the lever to deform by interference with the mating connector in a process of fitting the connector housing with the mating connector, thereby releasing an engagement of the protrusion part and the regulating groove to allow a rotation operation of the lever.

Accordingly, the protrusion part and the regulating groove, which engage with one another when the lever is at the initial position, are provided between the shaft part and the shaft hole of the rotation or pivotal mechanism that enables the lever to rotate with respect to the connector housing.

As a result of this, the lever particularly is held at the initial position.

Moreover, the shape of the lever itself particularly is deformed to cause the protrusion part to separate from the regulating groove in a process of fitting the connector housing with the mating connector, thereby particularly releasing the engagement of the protrusion part and the regulating groove.

In this way, it particularly is not necessary to use a moving piece that moves with respect to a lever main body, as a structure for holding the lever at the initial position.

Accordingly, it becomes possible to improve the overall operability and/or the reliability of the position holding mechanism that holds the lever at the initial position.
[2] Particularly, the lever has at least one arm part on which the operation mechanism is disposed, and the position holding mechanism causes the arm part to deform by interference with the mating connector so as to reduce or substantially eliminate warpage in a process of fitting the connector housing with the mating connector, thereby releasing the engagement of the protrusion part(s) and the regulating groove(s).

Further particularly, the lever has a pair of arm parts on each of which the operation (rotation or pivotal) mechanism is disposed, the pair of arm parts are each formed in a shape with a substantially symmetrical warpage, and the position holding mechanism causes the pair of arm parts to deform by interference with the mating connector so as to reduce or substantially eliminate warpage in a process of fitting the connector housing with the mating connector, thereby releasing an engagement of the protrusion part and the regulating groove.

Accordingly, the protrusion part and the regulating groove are engaged by using the warped shape of the arm part(s) of the lever, thereby causing the lever to be held at the initial position.

Moreover, warpage of the arm part(s) of the lever particularly is reduced or substantially eliminated, in a process of fitting the connector housing with the mating connector, thereby causing the engagement of the protrusion part and the regulating groove to be eliminated.

In this way, it particularly becomes possible to switch between engagement and disengagement of the protrusion part and the regulating groove, by a simple structure using the warped shape of the arm parts of the lever.
[3] Further particularly, the lever-type connector includes at least one warpage elimination mechanism that adds a load to eliminate warpage in the lever when fitting the connector housing with the mating connector.

Accordingly, the warpage elimination mechanism particularly assists the elimination of warpage of the arm parts of the lever, when the connector housing is fitted with the mating connector.

Accordingly, since it particularly becomes possible to sufficiently eliminate warpage, the certainty of separation of the protrusion part from the regulating groove is improved.
[4] Further particularly, the at least one protrusion part is formed on a side surface of the shaft part so as to protrude in a direction intersecting an axial direction of the shaft part, and the at least one regulating groove is formed on an inner circumferential surface of the shaft hole to thereby regulate operation (rotation or pivotal movement) of the lever in a direction of the fitted position, the regulating groove particularly capable of making contact with the protrusion part.

Accordingly, the protrusion part for holding the lever at the initial position particularly is formed by using a shape originally present in the shaft part. Accordingly, it is not necessary to perform a significant design change.
[5] Further particularly, the shaft part particularly causes the protrusion part to pass through at least one notched part formed in the shaft hole and causes the lever to rotate or pivot a certain amount to arrange the protrusion part on the regulating groove, thereby causing the lever to be arranged at the initial position.

Further particularly, the shaft hole includes at least one shaft removal prevention part supporting the protrusion part from a back surface so that the protrusion part does not come out from the shaft hole in a case where the protrusion part is arranged in the regulating groove.

Accordingly, since it particularly becomes difficult for the shaft part to separate from the shaft hole, the reliability as a lever-type connector device is improved.
[6] Further particularly, a group of the protrusion part and the regulating groove is provided on both sides in a direction intersecting an axial direction of the shaft part.

Accordingly, since a plurality of locations particularly are provided where the position of the lever is held by the protrusion part and the regulating groove, it becomes difficult for a situation to occur where the lever moves unintentionally from the initial position.

According to another aspect of the invention, there is provided a connector assembly comprising a lever-type connector according to the above aspect or a particular embodiment thereof and a mating connector connectable with each other.

According to a particular embodiment, in a case where the lever-type connector at least partly is fitted with the mating connector, the arm part can at least partly enter the inside of a fitting part of the mating connector, while warpage of the arm part substantially is eliminated, by having an inclined part of the arm part guided along a contact surface on the fitting part of the mating connector.

The present disclosure can improve the overall operability of a connection process, in particular by improving reliability of a position holding mechanism that holds a lever at an initial position.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a lever-type connector prior to being fitted with a mating connector.

FIG. 2 is a side view of the lever-type connector at a time when a lever is at an initial position.

FIG. 3 is a side view of the lever-type connector at a time when the lever is at a fitted position.

FIG. 4 is a perspective view of the lever-type connector after a fitting assurance member is operated.

FIG. 5 is an exploded perspective view showing a structure of a position holding mechanism.

FIG. 6 is a front view of the lever.

FIG. 7A is a state diagram prior to the lever being inserted inside the mating connector, and FIG. 7B is a state diagram after the lever is inserted inside the mating connector.

FIG. 8 is a cross-sectional view of a VIII-VIII line shown in FIG. 10B.

FIG. 9 is a perspective view showing the shape of a temporary fastening part.

FIG. 10A to FIG. 10D are each a perspective view showing a transition of a state of the position holding mechanism in accordance with a rotation operation of the lever.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### (Lever-Type Connector 1)

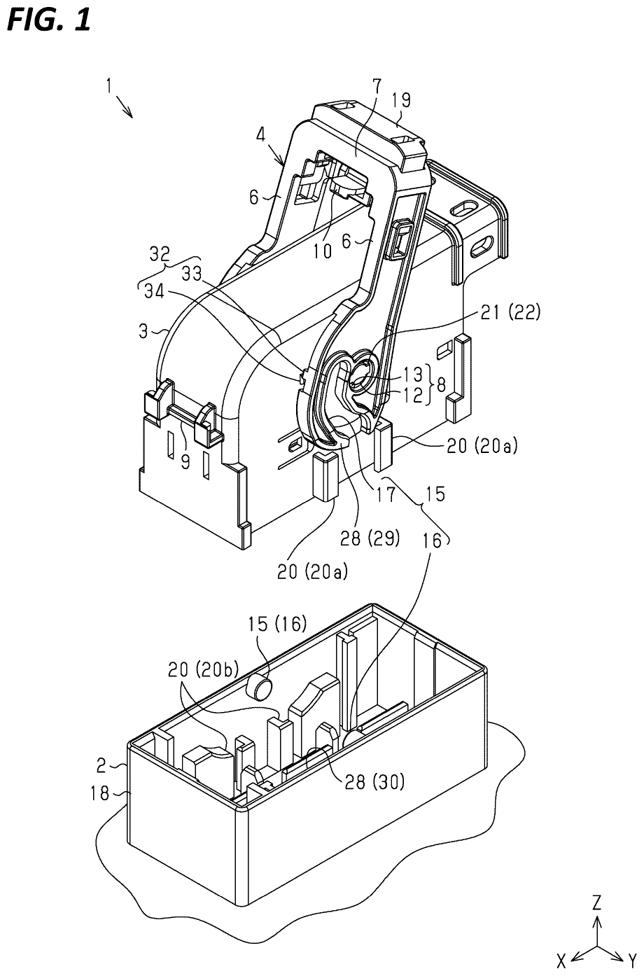

As shown in FIG. 1, a lever-type connector 1 includes a connector housing 3 fitted or fittable with a mating connector 2, and a lever 4 rotatably or pivotably attached to the connector housing 3.

One or more, particularly a plurality of electrical terminals (illustration omitted) are provided in each of the mating connector 2 and the connector housing 3.

One of the lever-type connector 1 and the mating connector 2 is a male connector, and the other one is a female connector.

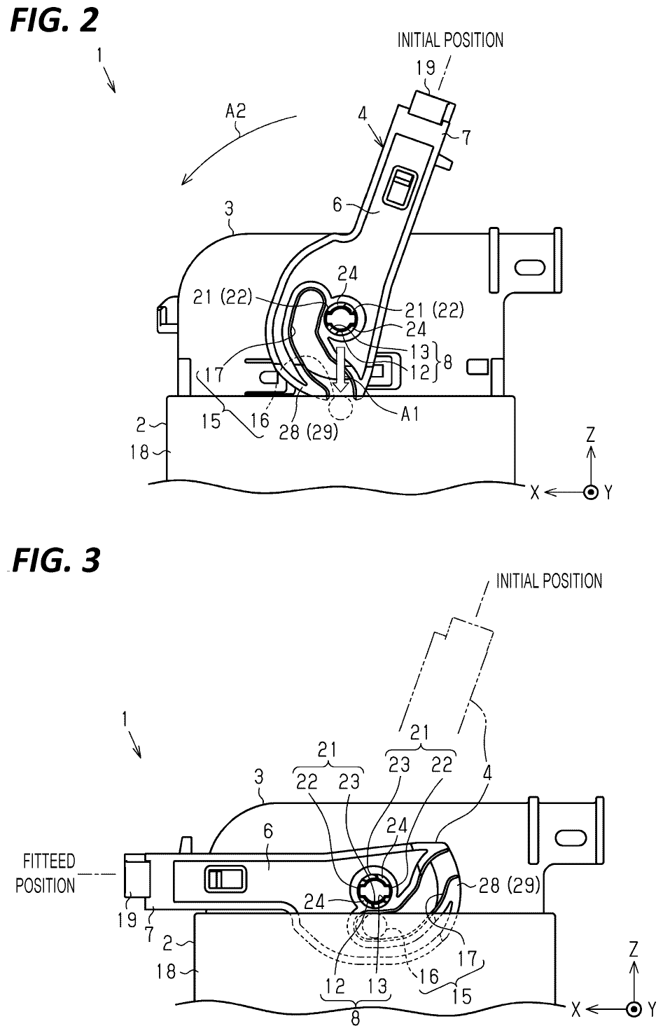

As shown in FIG. 2 and FIG. 3, in a case where the lever-type connector 1 is fitted with the mating connector 2, the lever 4 is capable of performing a rotation or pivotal operation between an initial position (refer to FIG. 2) and a fitted position (refer to FIG. 3).

The lever-type connector 1 is connected to the mating connector 2, by having the connector housing 3 drawn into the mating connector 2 along the arrow A1 direction of FIG. 2, in a process of operating the lever 4 from the initial position to the fitted position.

### (Lever 4)

As shown in FIG. 1, the lever 4 includes one or more, particularly a pair of arm parts 6, and particularly a connection part 7 that couples the pair of arm parts 6.

The lever 4 is rotatably or pivotably to be attached to the connector housing 3, via a rotation mechanism 8 provided between the arm part(s) 6, particularly each of the pair of arm parts 6, and the connector housing 3.

In this way, the lever 4 specifically includes the pair of arm parts 6 on each of which the rotation mechanism 8 is arranged.

In a case where the direction that the pair of arm parts 6 particularly are lined up is set as a width direction (Y-axis direction in FIG. 1), the rotation mechanism 8 will be provided on both sides (FIG. 1 illustrates only one side) in the width direction.

At least one lock piece 10, which engages with at least one engagement protrusion 9 of the connector housing 3 when the lever 4 is rotatably or pivotably operated to the fitted position, is formed on the lever 4.

### (Rotation Mechanism 8)

As shown in FIG. 1 and FIG. 2, the rotation mechanism 8 includes a shaft part 12 formed on one of the connector housing 3 and the lever 4, and a shaft hole 13 formed on the other one of the connector housing 3 and the lever 4.

In the case of the present example, the shaft part 12 is formed on the connector housing 3, and the shaft hole 13 is formed on the lever 4.

The shaft part 12 particularly is formed on both side surfaces of the connector housing 3.

The shaft part 12 is formed in a shape that extends substantially along a width direction (Y-axis direction in FIG. 1 or the like), which is the direction that the pair of arm parts 6 are lined up. The shaft hole 13 is formed on each of the pair of the arm parts 6.

The lever 4 is switched or displaced to the fitted position, by performing a rotation or pivotal operation from the initial position to the fitted position direction (arrow A2 direction in FIG. 2: counterclockwise direction on paper).

At this time, the lever 4 rotates or pivots around the shaft part 12 of the rotation mechanism 8.

### (Cam Mechanism 15)

As shown in FIG. 1, at least one cam mechanism 15, which particularly generates a load to substantially completely fit the lever-type connector 1 with the mating connector 2, in a process of performing a rotation or pivotal operation around the lever 4, is provided between the mating connector 2 and the lever 4.

The cam mechanism 15 particularly is provided on both sides in a width direction (Y-axis direction in FIG. 1 or the like), which particularly is the direction that the pair of arm parts 6 are lined up.

The cam mechanism 15 includes, for example, a cam pin 16 formed on the mating connector 2, and a cam groove 17 formed on the lever 4.

The cam pin 16 of the present example is formed in or on (particularly an inner surface of) the fitting part 18, to which the connector housing 3 is fitted, in the mating connector 2.

The cam groove 17 of the present example is formed on or in the arm part(s) 6, particularly on or in particularly an outer surface of each of the pair of arm parts 6.

The cam groove 17 is formed, for example, in a groove shape that enables rotational or pivotal motion of the lever 4 to be substantially converted into linear motion of the connector housing 3.

Specifically, when the lever 4 is operated from the initial position to the fitted position, the cam mechanism 15 converts rotational or pivotal motion of the lever 4 substantially into linear motion by subduction of the connector housing 3, by having the curved shaped cam groove 17 substantially slide the cam pin 16.

As a result, the lever-type connector 1 moves from the initial position (refer to FIG. 2) prior to an operation of the lever 4 to the fitted position (refer to FIG. 3).

In this way, the lever-type connector 1 is connected to the mating connector 2, by having the connector housing 3 drawn into the mating connector 2, in a process of operating the lever 4 from the initial position to the fitted position.

### (Fitting Assurance Member 19)

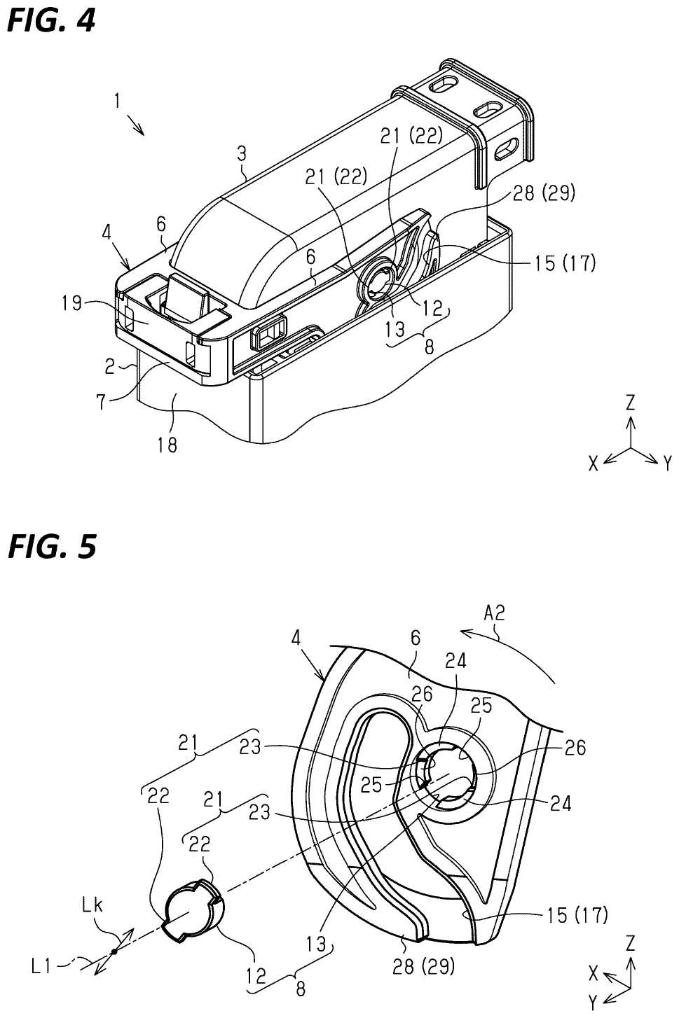

As shown in FIG. 1 and FIG. 4, the lever-type connector 1 includes at least one fitting assurance member 19 for detecting whether or not the lever 4 has correctly reached the fitted position.

The fitting assurance member 19 particularly is or comprises a so-called CPA (connector position assurance) member.

The fitting assurance member 19 is capable of recognizing that the lever 4 has reached the fitted position, by having a pressing operation allowed in a case where the lever 4 reaches the fitted position.

### (Guidance Part 20)

As shown in FIG. 1, at least one guidance part 20, which substantially guides fitting of the mating connector 2 and the connector housing 3, particularly is provided between the mating connector 2 and the connector housing 3.

The guidance part 20 of the present example substantially guides linear movement of the connector housing 3 with respect to the mating connector 2, when the connector housing 3 is fitted with the mating connector 2 by a rotation or pivotal operation of the lever 4 to the fitted position.

The guidance part 20 particularly includes at least one guidance rail 20a formed on a side surface of the connector housing 3, and/or at least one rail groove 20b formed on an inner surface of the fitting part 18 in order to at least partly insert the guidance rail 20a.

The guidance rail 20a particularly is formed on both side surfaces of the connector housing 3. The rail groove 20b particularly is formed at two substantially opposing locations on an inner surface of the fitting part 18.

In this way, a group of the guidance rail 20a and the rail groove 20b particularly is formed in two groups.

Note that, in FIG. 1, from among the two groups of the group of the guidance rail 20a and the rail groove 20b, the guidance rail 20a of one group is illustrated, and the rail groove 20b of the other group is illustrated.

### (Position Holding Mechanism 21)

As shown in FIG. 5, the lever-type connector 1 particularly includes at least one position holding mechanism 21 for holding the lever 4 at the initial position prior to being fitted with the mating connector 2.

Specifically, the position holding mechanism 21 holds the lever 4 at the initial position, by having the at least one protrusion part 22 formed on one of the shaft part 12 and the shaft hole 13 engage with the at least one regulating groove 23 formed on the other one of the shaft part 12 and the shaft hole 13.

The position holding mechanism 21 of the present example is set with the protrusion part 22 formed on the connector housing 3 and the regulating groove 23 formed on the lever 4.

Note that, while the position holding mechanism 21 particularly is provided on both sides (FIG. 5 or the like illustrates only one side) in a width direction (Y-axis direction of FIG. 5 or the like), which is the direction that the pair of arm parts 6 are lined up, only one side will be described here.

The protrusion part 22 particularly is formed on a side surface of the shaft part 12 so as to protrude in a direction (arrow Lk direction of FIG. 5) intersecting an axial direction (direction of shaft center L1) of the shaft part 12.

The regulating groove 23 particularly is formed on an inner circumferential surface of the shaft hole 13, in order to regulate rotation or pivotal movement of the lever 4 to a fitted position direction (arrow A2 direction of FIG. 5) by substantially making contact with the protrusion part 22.

Specifically, the regulating groove 23 is formed on an inner circumferential surface of the shaft hole 13 that is capable of making contact with the protrusion part 22.

The regulating groove 23 of the present example is formed by causing a part of the regulating projection 24 projected on an inner circumferential surface of the shaft hole 13 to be indented.

Specifically, the regulating groove 23 is formed by causing an end part of the regulating projection 24 to be indented in a rotation direction (arrow direction of FIG. 5) of the lever 4.

A group of the protrusion part 22 and the regulating groove 23 particularly is provided on both sides in a direction (arrow Lk direction of FIG. 5) intersecting an axial direction of the shaft part 12.

At least one notched part 25, through which the protrusion part 22 of the shaft part 12 passes when the shaft part 12 at least partly is inserted into the shaft hole 13, is formed on an inner circumferential surface of the shaft hole 13.

In this way, the shaft part 12 particularly causes the protrusion part 22 to pass through the notched part 25 formed in the shaft hole 13, and/or causes the lever 4 to rotate a certain amount to arrange the protrusion part 22 on the regulating groove 23, thereby causing the lever 4 to be arranged at the initial position.

The notched part 25 of the present example is formed in a pair so as to oppose one another.

The shaft hole 13 includes at least one shaft removal prevention part 26 supporting the protrusion part 22 (particularly from a back surface) so that the protrusion part 22 does not come out from the shaft hole 13, in a case where the protrusion part 22 is arranged in the regulating groove 23.

The shaft removal prevention part 26, for example, forms a bottom part of the regulating groove 23, and is thereby formed at a position a certain amount lower from the surface of the regulating projection 24.

The shaft removal prevention part 26 of the present example is integrally or unitarily formed with the regulating projection 24.

### (Warped Shape of Arm Parts 6 of Lever 4)

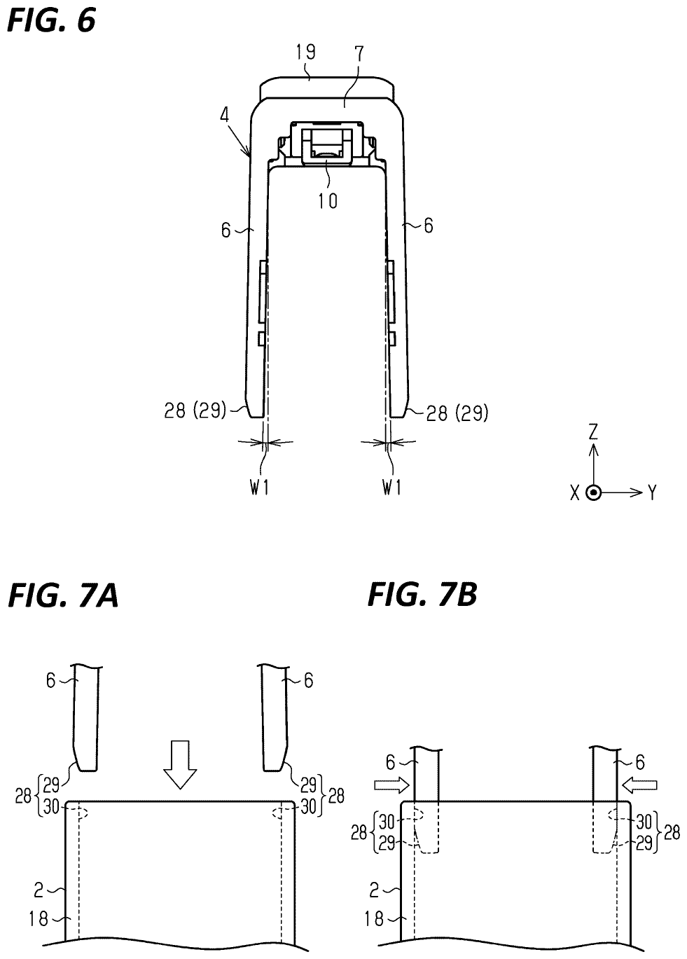

As shown in FIG. 6, the pair of arm parts 6 particularly are each formed in a shape having a symmetrical warpage.

In the case of the present example, the pair of arm parts 6 are formed in a shape where the tip ends are opened away from one another.

A warpage amount W1 of the one or more, particularly the pair of arm parts 6 is set to a value where the protrusion part 22 of the shaft part 12 is capable of being engaged with the regulating groove 23 of the shaft hole 13, when the lever 4 is positioned at the initial position.

### (Warpage Elimination Mechanism 28)

As shown in FIG. 7A and FIG. 7B, the lever-type connector 1 particularly includes at least one warpage elimination mechanism 28, which adds a load in order to eliminate warpage in the lever 4, when the connector housing 3 is fitted with the mating connector 2.

The warpage elimination mechanism 28 of the present example includes an inclined part 29 formed on a tip end outer surface of the arm part 6 of the lever 4, particularly each of the arm parts 6 of the lever 4, and a contact surface 30 that makes contact with the inclined part 29 on an inner surface of the fitting part 18 of the mating connector 2.

The warpage elimination mechanism 28 particularly is guided so as to insert each of the arm parts 6 into the fitting part 18, while eliminating warpage of the arm part(s) 6, by the inclined part 29 on the tip end of the arm part(s) 6, particularly of each of the arm parts 6.

When the arm part(s) 6 at least partly is/are inserted into the fitting part 18, the warpage elimination mechanism 28 particularly maintains a state where warpage is eliminated, by supporting the arm part(s) 6 with the contact surface 30 of the fitting part 18.

### (Release of Engagement of Protrusion Part 22 and Regulating Groove 23 in Position Holding Mechanism 21)

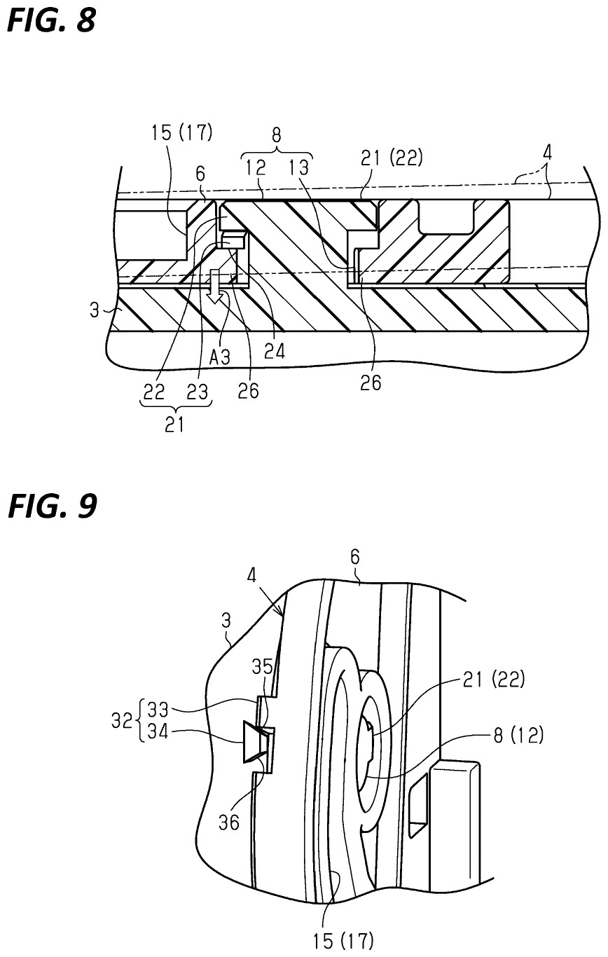

As shown in FIG. 8, the position holding mechanism 21 particularly causes the lever 4 to deform by interference with the mating connector 2 in a process of fitting the connector housing 3 with the mating connector 2, thereby making the arm part(s) 6 move in a direction (arrow A3 direction within the figure) away from the protrusion part 22 of the shaft part 12.

As a result of this, the position holding mechanism 21 particularly causes the engagement of the protrusion part 22 and the regulating groove 23 to be released to allow a rotation operation of the lever 4.

In the case of the present example, the pair of arm parts 6 of the lever 4 are formed in a warped shape where the tip ends are opened away from one another.

Accordingly, the position holding mechanism 21 of the present example causes the pair of arm parts 6 to deform by interference with the mating connector 2 so as to substantially eliminate or reduced warpage, in a process of fitting the connector housing 3 with the mating connector 2, thereby releasing the engagement of the protrusion part 22 and the regulating groove 23.

Namely, warpage of the arm part(s) 6 opened to the outside (above direction on the paper surface of FIG. 8) is deformed in a shape to the inside (below direction of the paper surface of FIG. 8), in a process of fitting of the mating connector 2 and the connector housing 3, thereby releasing the engagement of the position holding mechanism 21.

### (Temporary Fastening Part 32)

A shown in FIG. 9, the lever-type connector 1 particularly includes at least one temporary fastening part 32, which temporarily fastens the lever 4 at the initial position.

The temporary fastening part 32 particularly includes a first protrusion 33 formed on an inner surface of the lever 4, and a second protrusion 34 formed on a side surface of the connector housing 3 so as to come into contact with the first protrusion 33.

A first inclined part 35, which comes into contact with the first protrusion 33, and a second inclined part 36, which is disposed on an opposite side to the first inclined part 35 in a longitudinal direction of the arm parts 6 of the lever 4, particularly are formed on the second protrusion 34.

### [Action]

Next, the action of the lever-type connector 1 of the present embodiment will be described.

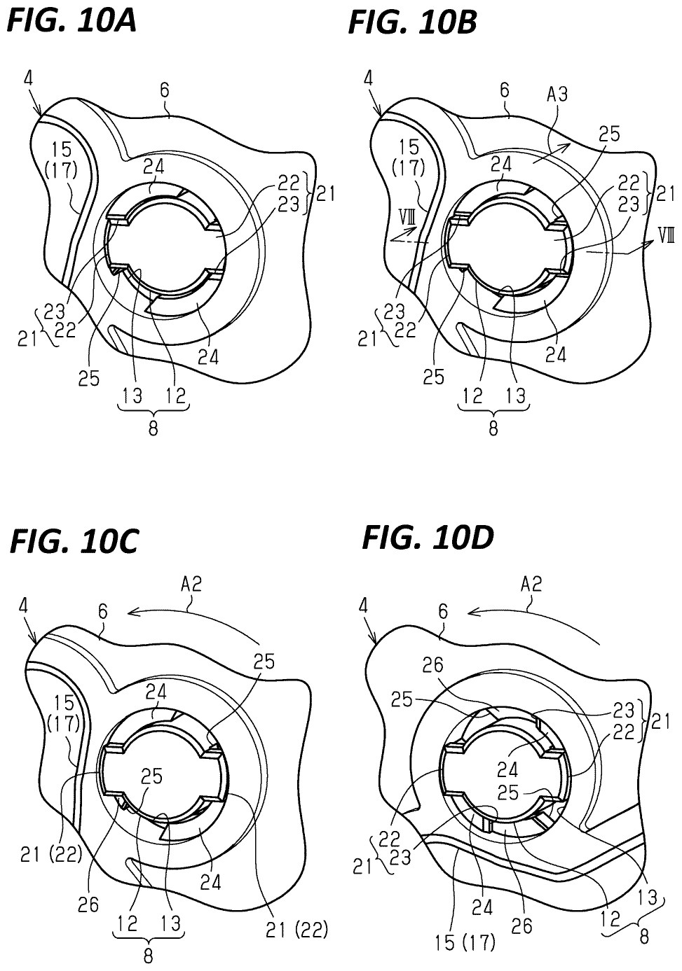

As shown in FIG. 10A, since the arm part(s) 6 of the lever 4 (particularly each) take(s) a state substantially along the outside, in a state prior to the lever-type connector 1 being fitted with the mating connector 2, the protrusion part 22 of the shaft part 12 particularly is engaged or engageable with the regulating groove 23 of the shaft hole 13.

At this time, since an end part of the protrusion part 22 substantially opposite the regulating projection 24 and a wall of the regulating groove 23 particularly are in a state where capable of coming into contact, a rotation or pivotal operation of the lever 4 from the initial position to the fitted position cannot be performed.

Namely, a rotation or pivotal operation towards or to a fitted position direction (arrow A2 direction of FIG. 10C or the like) of the lever 4 is prohibited.

As a result of this, the lever 4 is maintained or positioned at the initial position.

Moreover, at the time when the lever 4 is at the initial position, a load due to warpage of the lever 4 particularly acts on the protrusion part 22 from the shaft removal prevention part 26.

Namely, at the time when the lever 4 is at a position prior to operation, the shaft removal prevention part 26 of the lever 4 particularly is forcibly pressed on the protrusion part 22 of the shaft part 12.

Accordingly, it is more difficult for the lever 4 to move from the initial position.

In addition, since the lever 4 particularly is held also by the temporary fastening part 32, it is more difficult for the lever 4 to move from the initial position.

As shown in FIGS. 7A and 7B, in a case where the lever-type connector 1 at least partly is fitted with the mating connector 2, the arm part(s) 6 particularly enter(s) the inside of the fitting part 18, specifically while warpage of the arm part(s) 6 is eliminated, by having the inclined part 29 of the arm part(s) 6 (particularly each of the arm parts 6) guided along the contact surface 30 on an inner surface of the fitting part 18 of the mating connector 2.

In this way, warpage of the lever 4 particularly is eliminated by being pressed by the contact surface 30 of the fitting part 18, in a process where a tip end of the lever 4 enters the inside of the fitting part 18 of the mating connector 2.

In the case of the present example, the lever 4 is deformed so that the arm part(s) 6 close or move closer to the connector housing 3, by being pressing at the contact surface 30 of the fitting part 18.

As shown in FIG. 8 and FIG. 10B, in a case where the lever-type connector 1 is deformed so that the arm part(s) 6 close, in a process of being fitted with the mating connector 2, the protrusion part 22 of the shaft part 12 particularly is separated from the regulating groove 23, by having the arm part(s) 6 move in a direction (arrow A3 direction shown in FIG. 8 and FIG. 10B) away from the protrusion part 22.

As a result of this, the engagement of the protrusion part 22 and the regulating groove 23 is eliminated.

Accordingly, it becomes possible to rotatably or pivotably operate the lever 4 of the initial position to the direction of the fitted position.

As shown in FIG. 10C, when the lever 4 of the initial position is displaceably (rotatably or pivotably) operated to the direction of the fitted position, in a state where the protrusion part 22 is separated from the regulating groove 23, the protrusion part 22 particularly is in a state where riding over the surface of the regulating projection 24.

Namely, since the protrusion part 22 particularly no longer receives interference of the regulating groove 23, a rotation operation of the lever 4 from this point onward is allowed.

As shown in FIG. 10D, when the lever 4 is rotatably or pivotably operated from the initial position substantially to the fitted position, the protrusion part 22 particularly is positioned at an end part on the opposite side to a riding over location in the regulating projection 24, thereby remaining on the regulating projection 24.

Moreover, at a time when the lever 4 is positioned at the fitted position, the lock piece 10 of the lever 4 particularly is engaged with the engagement protrusion 9 of the connector housing 3, thereby causing the lever 4 to be held or positioned at the fitted position.

Moreover, whether or not the lever 4 is operated at the fitted position and both connectors are completely fitted particularly is or can be recognized by whether or not pressing of the fitting assurance member 19 attached to the lever 4 is possible.

### Effect of Embodiments

Effects such as follows can be obtained, by the lever-type connector 1 of the above embodiment.
(1) A lever-type connector 1 is connected to a mating connector 2 by having a connector housing 3 to be fitted with the mating connector 2 drawn into the mating connector 2 in a process of operating a lever 4 from an initial position to a fitted position, the lever 4 being rotatably provided on the connector housing 3.

The lever-type connector 1 particularly includes a rotation mechanism 8 and a position holding mechanism 21.

The rotation mechanism 8 particularly enabling the lever 4 to rotate or pivot with respect to the connector housing 3 by at least partly inserting a shaft part 12 formed on one of the connector housing 3 and the lever 4 into a shaft hole 13 formed on another one of the connector housing 3 and the lever 4.

The at least one position holding mechanism 21 particularly holds or positions the lever 4 at the initial position by having at least one protrusion part 22 formed on one of the shaft part 12 and the shaft hole 13 particularly engage with at least one regulating groove 23 formed on another one of the shaft part 12 and the shaft hole 13 in a case where the lever 4 substantially is positioned at the initial position.

The position holding mechanism 21 particularly causes the lever 4 to deform by interference with the mating connector 2 in a process of at least partly fitting the connector housing 3 with the mating connector 2, thereby releasing an engagement of the protrusion part(s) 22 and the regulating groove(s) 23 to allow a rotation or pivotal operation of the lever 4.

Accordingly, the protrusion part(s) 22 and the regulating groove(s) 23, which engage with one another when the lever 4 is at the initial position, are provided between the shaft part 12 and the shaft hole 13 of the rotation mechanism 8 for enabling the lever 4 to rotate or pivot with respect to the connector housing 3.

As a result of this, the lever 4 particularly is held or positioned at the initial position.

Moreover, the shape of the lever 4 itself is deformed to particularly cause the protrusion part 22 to separate from the regulating groove 23 in a process of fitting the connector housing 3 with the mating connector 2, thereby releasing the engagement of the protrusion part 22 and the regulating groove 23.

In this way, it particularly is not necessary to use a moving piece that moves with respect to a lever main body, as a structure for holding the lever 4 at the initial position.

Accordingly, the reliability of the position holding mechanism 21 for holding the lever 4 at the initial position can be improved.
(2) The lever 4 particularly has one or more, particularly a pair of arm parts 6 on (particularly each of) which the rotation mechanism 8 is disposed.

Specifically, the pair of arm parts 6 are each formed in a shape with a substantially symmetrical warpage.

The position holding mechanism 21 particularly causes the one or more, particularly the pair of arm parts 6, to deform by interference with the mating connector 2 so as to reduce or substantially eliminate warpage in a process of fitting the connector housing 3 with the mating connector 2, thereby releasing an engagement of the protrusion part 22 and the regulating groove 23.

According to this configuration, the protrusion part 22 and the regulating groove 23 particularly are engaged by using the warped shape of the arm part(s) 6 of the lever 4, thereby causing the lever 4 to be held at the initial position.

Moreover, warpage of the arm part(s) 6 of the lever 4 particularly is reduced or substantially eliminated, in a process of fitting the connector housing 3 with the mating connector 2, thereby causing the engagement of the protrusion part 22 and the regulating groove 23 to be substantially eliminated.

In this way, engagement and disengagement of the protrusion part 22 and the regulating groove 23 particularly can be switched, by a simple structure using the warped shape of the arm parts 6 of the lever 4.
(3) The lever-type connector 1 includes at least one warpage elimination mechanism 28 for adding a load to eliminate warpage in the lever 4 when fitting the connector housing 3 with the mating connector 2.

According to this configuration, the warpage elimination mechanism 28 particularly assists the elimination of warpage of the arm parts 6 of the lever 4, when the connector housing 3 is fitted with the mating connector 2.

Accordingly, since it becomes possible to sufficiently eliminate warpage, the certainty of separation of the protrusion part 22 from the regulating groove 23 is improved.
(4) The at least one protrusion part 22 particularly is formed on a side surface of the shaft part 12 so as to protrude in a direction (arrow Lk direction shown in FIG. 5) intersecting an axial direction (direction of shaft center L1 shown in FIG. 5) of the shaft part 12.

The at least one regulating groove 23 particularly is formed on an inner circumferential surface of the shaft hole 13 to thereby regulate rotation or pivotal movement of the lever 4 in a direction of the fitted position, the regulating groove(s) 23 capable of making contact with the protrusion part(s) 22.

Accordingly, the protrusion part 22 for holding the lever 4 at the initial position particularly is formed by using a shape originally present in the shaft part 12.

Accordingly, it is not necessary to perform a significant design change.
(5) The shaft part 12 particularly causes the protrusion part 22 to pass through at least one notched part 25 formed in the shaft hole 13 and causes the lever 4 to rotate or pivot a certain amount to arrange the protrusion part 22 on the regulating groove 23, thereby causing the lever 4 to be arranged at the initial position.

The shaft hole 13 particularly includes at least one shaft removal prevention part 26 supporting the protrusion part 22 from a back surface so that the protrusion part 22 does not come out from the shaft hole 13 in a case where the protrusion part 22 is arranged in the regulating groove 23.

Accordingly, since it particularly becomes difficult for the shaft part 12 to separate from the shaft hole 13, the reliability as a lever-type connector 1 device is improved.
(6) A group of the protrusion part 22 and the regulating groove 23 particularly is provided on both sides in a direction (arrow Lk direction shown in FIG. 5) intersecting an axial direction (direction of shaft center L1 shown in FIG. 5) of the shaft part 12.

Accordingly, since a plurality of locations are provided where the position of the lever 4 particularly is held by the protrusion part 22 and the regulating groove 23, it becomes difficult for a situation to occur where the lever 4 moves unintentionally from the initial position.

According to the above, a lever-type connector is provided that can improve the reliability of a position holding mechanism that holds a lever at an initial position. A lever-type connector 1 includes a rotation mechanism 8 that enables a lever 4 to rotate with respect to a connector housing 3, and a position holding mechanism 21 that holds the lever 4 at an initial position. The position holding mechanism 21 holds the lever 4 at the initial position by having a protrusion part 22 formed on one of a shaft part 12 and a shaft hole 13 of the rotation mechanism 8 engage with a regulating groove 23 formed on another one of the shaft part 12 and the shaft hole 13 in a case where the lever 4 is positioned at the initial position. The position holding mechanism 21 causes the lever 4 to deform by interference with a mating connector 2 in a process of fitting the connector housing 3 with the mating connector 2, thereby releasing an engagement of the protrusion part 22 and the regulating groove 23 to allow a rotation operation of the lever 4.

### OTHER EMBODIMENTS

Note that, the present embodiment can be implemented by changes such as follows. The present embodiment and the following modified examples can be implemented in combination within a technically compatible range.
The connector housing 3 may have a shape that includes, for example, a main body such as an inner housing, and a cover fitted with the main body.

In this case, the shaft part 12 may be formed on the cover. Namely, the lever-type connector 1 may have a configuration in which the lever 4 is rotatably or pivotably attached to the shaft part 12 formed on the cover.
The protrusion part 22 particularly is not limited to being formed on a tip end of the shaft part 12, and may be formed midway on the shaft.
Warpage of the lever 4 particularly is not limited to a shape in which the tip ends of the arm part(s) 6, particularly of the pair of arm parts 6, are warped toward the outside one another, and particularly may have a shape in which the tip ends of the pair of arm parts 6 are warped toward the inside so as to approach one another.
The position holding mechanism 21 may be configured, for example, so that the regulating groove 23 is displaced to the outside with respect to the protrusion part 22 by deformation of the lever 4 to the outside, thereby releasing the engagement of the protrusion part 22 and the regulating groove 23.
The regulating projection 24 and the shaft removal prevention part 26 particularly are not limited to being a connected integrated shape, and they may be provided separately.
The lever 4 particularly is not limited to being made of resin, and may be made of metal.
The cam groove 17 of the lever 4 particularly is not limited to a recessed part, and may be, for example, a through hole (slit shape).
The cam pin 16 of the cam mechanism 15 particularly is not limited to being formed on an inner surface of the fitting part 18, and may be formed on an outer surface of the fitting part 18.
The mating connector 2 may include a specialized shape for eliminating warpage of the lever 4, as an element of the warpage elimination mechanism 28.
The group of the protrusion part 22 and the regulating groove 23 particularly may be only one group.
The shaft part 12 and the shaft hole 13 particularly may be set with the shaft part 12 formed on the lever 4 and the shaft hole 13 formed on the connector housing 3.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A lever-type connector to be connected to a mating connector by having a connector housing to be drawn into the mating connector in a process of operating a lever from an initial position to a fitted position, the lever being rotatably or pivotably provided on the connector housing, the lever-type connector comprising:
an operation mechanism that enables the lever to rotate or pivot with respect to the connector housing by at least partly inserting a shaft part formed on one of the connector housing and the lever into a shaft hole formed on another one of the connector housing and the lever; and
at least one position holding mechanism that holds the lever at the initial position by having at least one protrusion part formed on one of the shaft part and the shaft hole engage with at least one regulating groove formed on another one of the shaft part and the shaft hole in a case where the lever is positioned at the initial position, wherein
the position holding mechanism causes the lever to deform by interference with the mating connector in a process of at least partly fitting the connector housing with the mating connector, thereby releasing an engagement of the protrusion part and the regulating groove to allow a rotation or pivotal operation of the lever.

2. The lever-type connector according to claim 1, wherein
the lever has at least one arm part on which the operation mechanism is disposed, and
the position holding mechanism causes the arm part to deform by interference with the mating connector so as to reduce or substantially eliminate warpage in a process of fitting the connector housing with the mating connector, thereby releasing the engagement of the protrusion part and the regulating groove.

3. The lever-type connector according to claim 2, wherein
the lever has a pair of arm parts on each of which the operation mechanism is disposed,
the pair of arm parts are each formed in a shape with a substantially symmetrical warpage, and
the position holding mechanism causes the pair of arm parts to deform by interference with the mating connector so as to reduce or substantially eliminate warpage in a process of fitting the connector housing with the mating connector, thereby releasing the engagement of the protrusion part and the regulating groove.

4. The lever-type connector according to claim 2, further comprising:
at least one warpage elimination mechanism that adds a load to eliminate warpage in the lever when fitting the connector housing with the mating connector.

5. The lever-type connector according to claim 1, wherein
the at least one protrusion part is formed on a side surface of the shaft part so as to protrude in a direction intersecting an axial direction of the shaft part, and
the at least one regulating groove is formed on an inner circumferential surface of the shaft hole to thereby regulate rotation or pivotal movement of the lever in a direction of the fitted position, the regulating groove capable of making contact with the protrusion part.

6. The lever-type connector according to claim 5, wherein
the shaft part causes the protrusion part to pass through at least one notched part formed in the shaft hole and causes the lever to rotate or pivot a certain amount to arrange the protrusion part on the regulating groove, thereby causing the lever to be arranged at the initial position.

7. The lever-type connector according to claim 6, wherein the shaft hole includes at least one shaft removal prevention part supporting the protrusion part from a back surface so that the protrusion part does not come out from the shaft hole in a case where the protrusion part is arranged in the regulating groove.

8. The lever-type connector according to claim 1, wherein
a group of the protrusion part and the regulating groove is provided on both sides in a direction intersecting an axial direction of the shaft part.

9. A connector assembly comprising the lever-type connector according to claim 1 and a mating connector connectable with each other.

10. The connector assembly according to claim 9, wherein, in a case where the lever-type connector at least partly is fitted with the mating connector, the arm part can at least partly enter the inside of a fitting part of the mating connector, while warpage of the arm part substantially is eliminated, by having an inclined part of the arm part guided along a contact surface on the fitting part of the mating connector.
